(19) United States
(12) Patent Application Publication
(10) Pub. No.: US 2015/0096664 A1
(43) Pub. Date: Apr. 9, 2015

(54) PHENOLIC FOAM BOARD

(71) Applicant: KINGSPAN HOLDINGS (IRL) LIMITED, County Cavan (IE)

(72) Inventors: Vincent COPPOCK, Chesire (GB); Ruud ZEGGELAAR, JK Arnhem (NL); Richard WENHEM, Hereford (GB); Linzi HOBBS, Ludlow (GB)

(21) Appl. No.: 14/518,021

(22) Filed: Oct. 20, 2014

Related U.S. Application Data
(63) Continuation of application No. 13/412,956, filed on Mar. 6, 2012, now abandoned.
Application No. 13/412,956 is a continuation of application No. 12/223,254, filed on Jul. 25, 2008, now abandoned.

(30) Foreign Application Priority Data
Jan. 30, 2006 (IE) IE2006/0062

(51) Int. Cl. B32B 37/24; B32B 37/14; B32B 38/00; B32B 37/12

(52) U.S. Cl. CPC B32B 37/24; B32B 37/1284; B32B 37/144; B32B 38/0004; B32B 38/0036; B32B 38/164; B32B 2311/24; B32B 2305/022; B32B 2315/085; B32B 2317/122; B32B 2307/304; B32B 2371/00; B32B 2037/243; B32B 2307/7242; B32B 2419/00
USPC 156/79

(57) ABSTRACT

A rigid insulating phenolic foam body has at least one perforated facing. The facing is preferably perforated before the facing is adhered to the foam body. The facing may be a gas impermeable material such as a metallic foil. The perforations in the gas impermeable material reduce the drying and curing time, for phenolic foam bodies when compared with phenolic foam bodies with gas permeable facings.

This is a Continuation of application Ser. No. 12/223,254 filed Jul. 25, 2008, which in turn is a national stage of PCT/IE2007/000008 filed Jan. 30, 2007 and published in English.

### INTRODUCTION

Phenol foam is used in insulation applications for construction materials because of its superior thermal insulation and fire properties including low smoke emission and good fire resistance.

Phenol foam is generally produced by expanding and curing a foamable composition prepared by uniformly mixing a resole resin, (obtained by a poly condensation reaction of phenol and formaldehyde in the presence of an alkaline catalyst), a blowing agent (generally a volatile liquid or gas with a lower thermal conductivity than air), a surfactant, and a curing catalyst. Other additives can optionally be mixed into the resin such as plasticisers, flame retardants and pigments.

Foam insulation panels often have gas impermeable facings such as foil facings. These facings are bonded to the foam core by making use of the inherent adhesive ability of the foaming resin without the need for additional adhesives. This is known as autohesive bonding. Gas impermeable facings such as aluminium foil facings are used to reduce the emissivity of the product. Emissivity is the ratio of energy emitted by the facing to the energy emitted by a perfect black body, a low value indicating good heat reflection of the facing, which contributes to the insulation value of the final product.

During the polymerisation reaction of phenol and formaldehyde, a significant amount of water will be formed. This water has to be removed by drying to obtain a product with good dimensional stability, usually in a separate drying or curing step at elevated temperature. When gas impermeable facings are used, for example, aluminium foils, very long curing times will be needed to dry the product. Very high temperatures (i.e. above 100° C.) cannot be used for curing of these products as the vaporised water will cause excessive pressure in the closed cells of the foam leading to rupture of these cells and loss of blowing agent, which leads to relatively poor insulation values as the blowing agent is replaced by air.

In practice, the curing time of an insulation panel faced on both sides with non gas-permeable facings will depend on the product thickness. Insulation panels with gas impermeable facings will take more than 3 times longer to dry and cure than a panel with a gas permeable facing.

Products faced with non gas-permeable facings such as aluminium foils which are adhesively bonded to the product, after curing, are not commercially viable in view of the added handling costs involved.

### STATEMENTS OF INVENTION

The phenolic foam thermal insulation products of the invention have perforations in gas-impermeable facing material. These perforations reduce the drying and curing time when compared with gas permeable faced products. The aged thermal conductivity of such products is also improved. The perforations are preferably made in a gas-impermeable facing material prior to manufacture of the phenolic, insulation board. The phenolic foam insulation board has an aged thermal conductivity of less than 0.02 W/m.K when faced on both sides with perforated gas-impermeable facing materials which are autohesively bonded during manufacture. The perforations may be between 0.05 and 2 mm in diameter and may be spaced from 2 mm to 50 mm apart. The perforations are typically between 0.1 and 1.5 mm diameter and are spaced from 3 mm to 30 mm apart.

The perforations can be made from one or both sides of the facing.

The perforations may be of any shape and may be made using a tool which is, for example, tubular, conical or pyramidal in shape. A pyramidal spiker may create an X-shaped perforation with a width of typically 1.0 mm with centres of typically 3.8 mm.

According to the invention there is provided a rigid phenolic insulating foam body having a pre-perforated facing.

In one embodiment the facing comprises a substantially gas impermeable material. The facing may comprise a metallic foil such as an aluminium foil. The facing may be a laminate such as a metallic foil laminated onto a glass tissue or a metallic foil laminated onto a Kraft paper.

In one embodiment the foam body comprises a board having an upper face and a lower face and the gas impermeable facing is applied to at least one face of the board. A facing is usually applied to both the upper and the lower faces of the board.

The invention also provides a method for manufacturing a foam body comprising the steps of:
leading a base facing to a lay down area;
laying liquid foam reactants down on the base facing;
at least one of the facings being pre-perforated;
leading an upper facing over the foam reactants;
leading the sandwich thus formed through an oven; and
cutting the foam board thus formed to a desired length.

Both of the facings may be pre-perforated.

At least one of the facings may comprise a substantially gas impermeable material. The facing may comprise a metallic foil such as an aluminium foil. The facing may be a laminate such as a metallic foil laminated onto a glass tissue or a metallic foil laminated onto a Kraft paper.

The invention also provides a rigid polymeric insulating phenolic foam body having a perforated facing. The facing may comprise a normally gas-impermeable material such as a metallic foil, for example an aluminium foil. The facing may be a laminate such as a metallic foil laminated onto a glass tissue or a metallic foil laminated onto a Kraft paper.

In one embodiment the foam body comprises a board having an upper face and a lower face and the facing is applied to at least one face of the board. A facing may be applied to both the upper and lower faces of the board.

The invention further provides a method for manufacturing a phenolic foam body, comprising the steps of:
leading a base facing to a lay down area;
laying liquid phenolic foam reactants down on the base facing;
leading an upper facing over the foam reactants;
leading the sandwich thus formed through an oven;
perforating at least one of the facings; and
cutting the foam board thus formed to a desired length.

In one embodiment both of the facings are perforated.

At least one of the facings may comprise a substantially gas impermeable material, such as a metallic foil, for example an aluminium foil. The facing may be a laminate such as a metallic foil laminated onto a glass tissue or a metallic foil laminated onto a Kraft paper.

### BRIEF DESCRIPTION OF THE DRAWINGS

The invention will be more clearly understood from the following description thereof given by way of example only with reference to the accompanying figures, in which:

FIGS. 1(a) and 1(b) are schematic views showing perforation patterns for pre-perforated facings;

FIG. 2 is a schematic view showing another perforation pattern;

FIG. 3 is a diagram illustrating the formation of perforations in a facing using a spiked roller;

FIG. 4 is a plan view of a perforated facing;

FIG. 5 is a perspective view of the perforated facing;

FIG. 6 is another diagram illustrating the formation of perforations in a facing;

FIGS. 7(a) and 7(b) are diagrams illustrating the formation of perforations in facings;

FIG. 8 is a diagram of a foam board with pre-perforated facings;

FIG. 9 is a side view illustrating the formation of perforations in the facings of a foam board; and

FIG. 10 is a cross sectional view illustrating the formation of perforations using the apparatus of FIG. 9.

### DETAILED DESCRIPTION

It has been surprisingly found that the presence of small perforations in a gas impermeable facing, will result in a shortened insulation board drying (curing) time following production of the board. This shortened drying time is comparable with the drying time taken for foam insulation products of the same thickness that have gas permeable facings such as glass fibre facings.

The perforations are preferably made in the facings of the phenolic foam insulation panel before the foam is applied to the facings. Alternatively, small perforations can be introduced into the facing, after forming the foam board. In the case of facings which are perforated before the foam is applied, the hole size and spacing is carefully selected (typically between 0.1 and 1.5 mm, generally less than 1 mm) to avoid bleed-through of the liquid pre-polymer.

### Example 1

In this case, the perforations are made in the facing itself, before the foaming process.

For this purpose, two different facings where perforated and used to make foam panels. The first facing consisted of an aluminium foil laminated onto glass tissue.

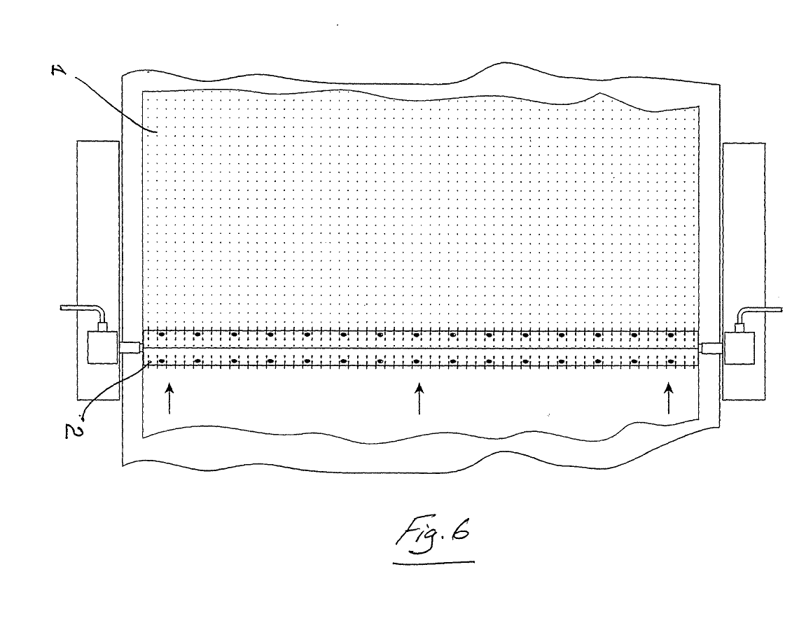

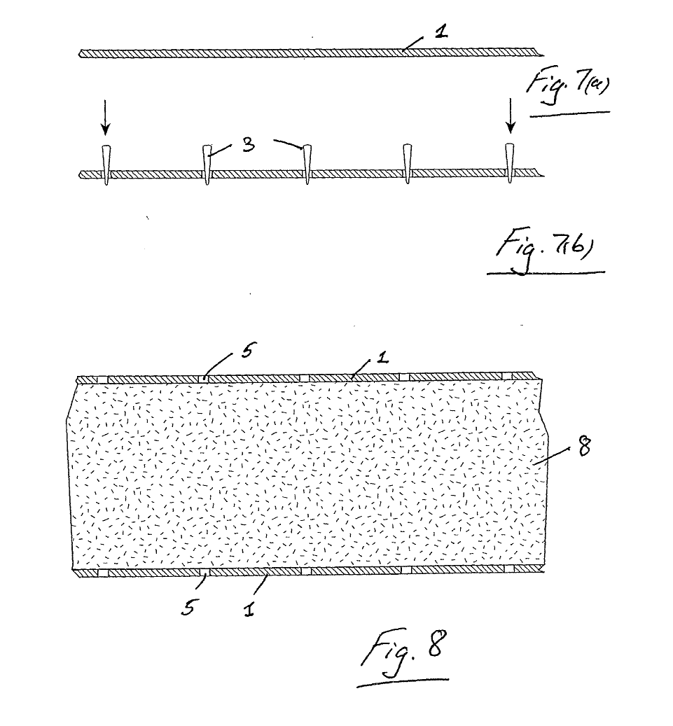

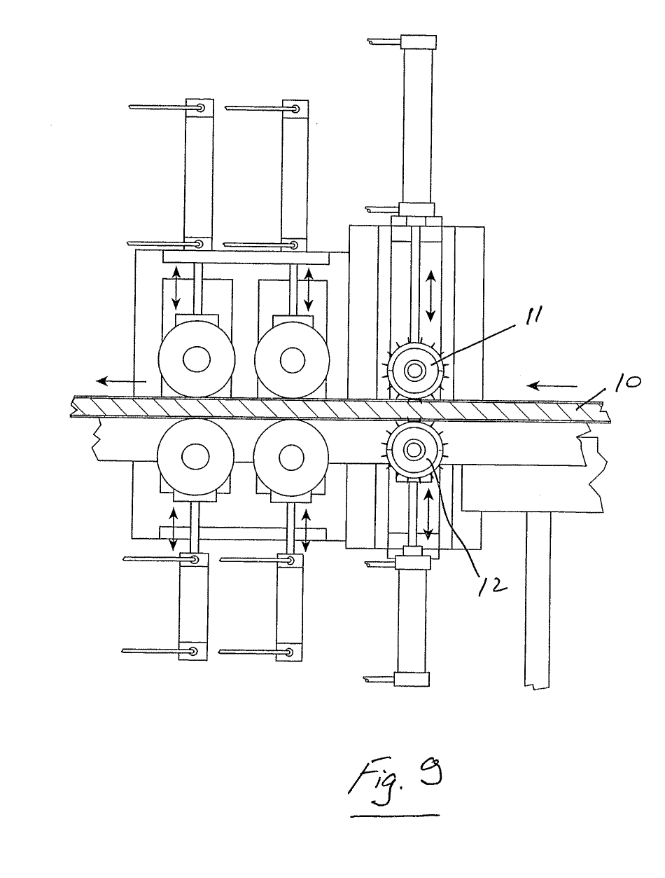

Referring to FIGS. 3 to 8 the facings 1 may be perforated using a spiked roller 2 with a plurality of spikes 3 which form a plurality of perforations 5 in the facing 1. A spiked roller is described in GB-A-2,383,971.

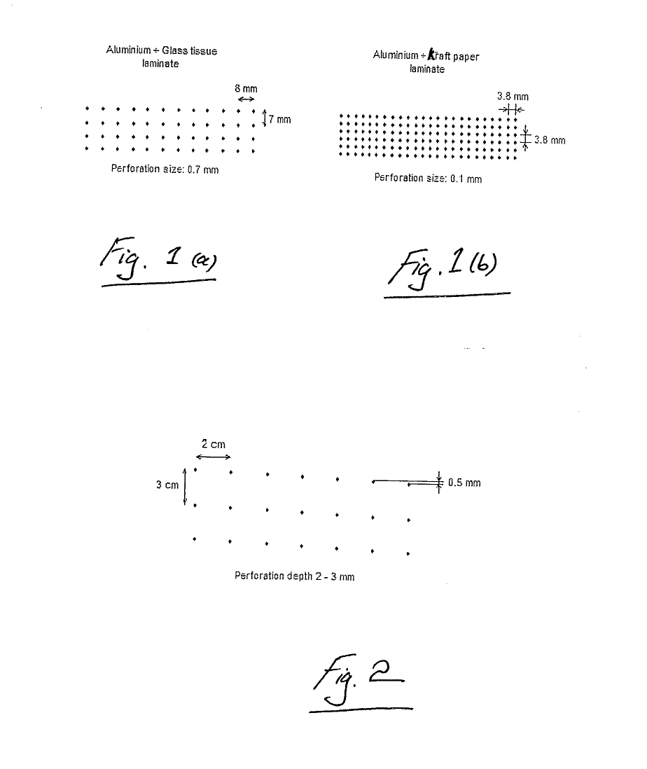

The perforation pattern for the aluminium-glass fibre facing, and the perforation size of 0.7 mm are given in FIG. 1(a).

With both facings perforated, phenolic foam insulation panels 8 with a thickness of 50 mm were produced.

Phenol formaldehyde foam insulation boards, with a thickness of 50 mm, were produced with gas impermeable facings comprising aluminium foil laminated onto glass tissue. The perforated facing was used as a facing on both sides. According to the process for producing phenolic foam of the present invention, a foamable phenolic resin composition is discharged on to a continuous running perforated facing and passed through a heated zone for foaming and moulding into phenolic foam products of predetermined shape. In this manufacturing process, the phenolic resin composition that has been discharged on to the running perforated facing material supported by a conveyor belt that passes into a heated oven typically at 50 to 100° C. for approximately 2 to 15 minutes. The top surface of the rising foam composition is pressed down with another perforated facing material carried by an upper conveyor belt. The thickness of the foam is controlled to the required predetermined thickness. The phenolic foam leaving the oven is then cut to a predetermined length.

Using the same process as described above a foam board was produced using facings comprising a Kraft paper-aluminium foil laminate. The perforation pattern for the aluminium-Kraft paper facing, and the perforation size of 0.1 mm are given in FIG. 1(b).The facings may be perforated using a helical spiked roller as described above. The perforated facing was used as a facing on both sides.

As a control reference, samples of the same thickness panel were made with the same facings but were non-perforated. These samples were dried in an oven at 80° C. for 5 hours.

Table 1 shows the weight loss of the product after 5 hours of drying at 80° C.

TABLE 1
Weight loss for perforated and non-perforated facings for panel thickness
50 mm.

| | Weight loss |
|---|---|
| Description | % |
| Perforated Aluminium kraft paper laminate | 7.5 |
| (perforation size 0.1 mm diameter) | |
| Non perforated Aluminium kraft paper laminate | 4.6 |
| Perforated Aluminium glass tissue laminate | 10.8 |
| (0.7 mm diameter) | |
| Non perforated Aluminium glass tissue laminate | 4.7 |

Perforation of the foils results in an increase of the drying rate of foam panel products. A perforation size of 0.1 mm approximately doubles the drying rate.

The preferred embodiment of the invention is pre-perforation of the facings as described in Example 1 because this has the advantage of eliminating the occasional formation of gas blisters between the facing and the foam surface. These blisters can occur when manufacturing with a gas-tight facing and result when gas is released from the foam during processing (from water vapour or blowing agent) which cannot escape through the gas-impermeable facing, and results in a gas bubble between the facing and the foam surface with loss of facing adhesion in that area These blisters can vary in size from a few mm diameter to tens of centimetres and are undesirable both aesthetically and in their reduction of facing tensile properties.

### Example 2

Phenol formaldehyde foam insulation boards, with a thickness of 80 mm, were produced with a gas impermeable two-layer aluminium foil-glass fibre tissue laminate facing on both sides. The assembly of this two-layer facing was arranged such that the glass fibre layer of the two-layer facing was bonded to the phenolic foam. According to the process for producing phenolic foam of the present invention, a foamable phenolic resin composition is discharged on to a continuous running facing and passed through a heated zone for foaming and moulding into phenolic foam products of predetermined shape. In this manufacturing process, the phenolic resin composition that has been discharged on to the running facing material supported by a conveyor belt that passes into a heated oven typically at 50 to 100° C. for approximately 2 to 15 minutes. The top surface of the rising foam composition is pressed down with another facing material carried by an upper conveyor belt. The thickness of the foam is controlled to the required predetermined thickness. The phenolic foam leaving the oven is then cut to a predetermined length.

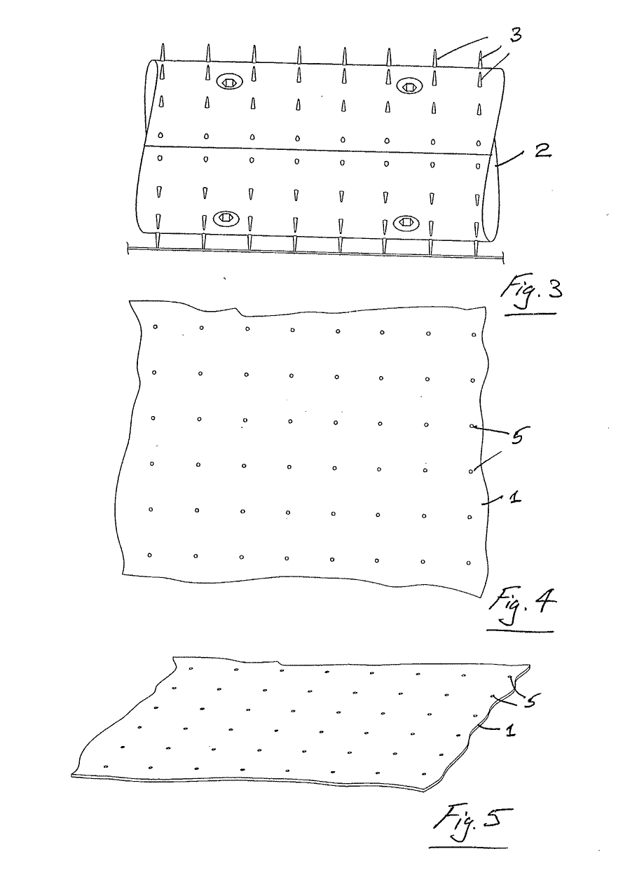

Thereafter, one of these foam insulation panels was perforated on one side using a helical spiked roller as described in GB-A-2,383,971. The pattern and depth of the perforations is given in FIG. 2. The diameter of each of the perforations is approximately 0.5 mm.

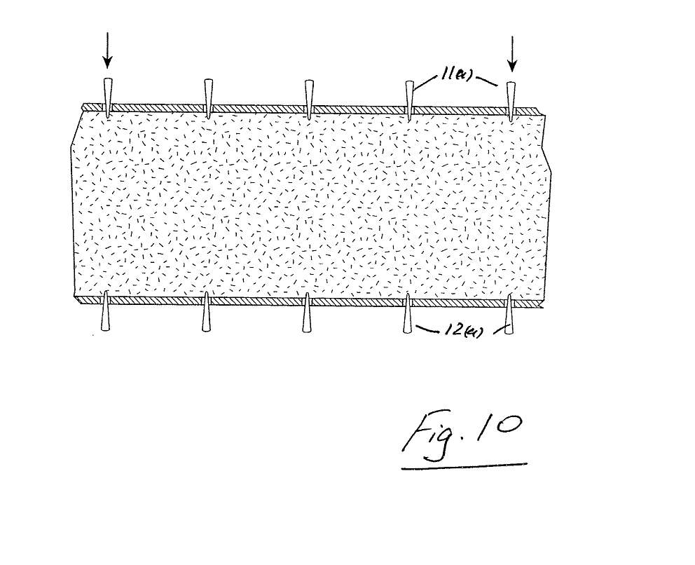

Another 80 mm thick phenol formaldehyde foam insulation panel, which had been faced on both sides with the same aluminium foil-glass fibre tissue facing was perforated on both sides, according to the pattern given in FIG. 2 using the same helical spiker device. This arrangement is illustrated in FIGS. 9 and 10 in which a foam board 10 is passed between two helical spiked rollers 11,12 with spikes 11a,12a to form a foam board 13 with facings 14,15 on both sides. Both of the facings 14,15 are perforated.

These perforated samples together with a sample of phenolic foam panel which had on both sides of the panel the same aluminium foil-glass tissue facing but without perforations and an insulation panel faced with gas permeable plain glass tissue were placed in an oven at 70° C. After 4, 8 and 12 hours, the weight loss of these samples was determined.

Table 2 gives the weight loss of these four samples as function of the drying time

TABLE 2
Weight loss as function of the drying time

| Description | Data | | |
|---|---|---|---|
| Product thickness [mm] | 80 | 80 | 80 |
| Drying time [hours] | 4 | 8 | 12 |
| Drying temperature [° C.] | 70 | 70 | 70 |
| Weight loss of double sided aluminium foil - glass | 0.45 | 0.72 | 1.16 |
| tissue faced product with no perforations [w %] | | | |
| Weight loss of double sided aluminium foil - glass | 2.75 | 4.04 | 5.48 |
| tissue faced product with single side of perforations | | | |
| [w %] | | | |
| Weight loss of double sided aluminium foil - glass | 4.11 | 6.95 | 8.86 |
| tissue faced product with double side perforations | | | |
| [w %] | | | |
| Weight loss of double sided glass tissue faced | 3.96 | 6.81 | 8.70 |
| product (reference sample) [w %] | | | |

Table 2 shows that the weight loss of the double-sided perforated product is comparable to the weight loss of the product faced with a gas permeable facing such as fibreglass tissue.

Table 3 shows the physical properties of these 80 mm thick samples after 8 hours of drying at 70° C. All measurements are performed according to EN13166 2001.

TABLE 3
Physical properties of perforated products.

| | | | | Thermal |
|---|---|---|---|---|
| | | | | Conductivity |
| | | | Initial | after 25 weeks |
| | | | Thermal | at 70° C. + |
| | Compressive | Delamination | Conductivity | 23° C./50% |
| | Strength | Strength | 4 days at 70° C. | RH |
| Description | [kPa] | [kPa] | [W/m · K] | [W/m · K] |
| Double sided aluminium foil - | 171 | 85 | 0.0194 | 0.0211 |
| glass fibre tissue faced product | | | | |
| (no perforations) | | | | |
| Double sided aluminium foil - | 164 | 92 | 0.0185 | 0.0194 |
| glass fibre tissue faced product | | | | |
| (single sided perforations) | | | | |
| Double sided aluminium foil - | 175 | 102 | 0.0185 | 0.0195 |
| glass fibre tissue faced product | | | | |
| (double sided perforations) | | | | |
| Double sided glass tissue | 169 | 95 | 0.0180 | 0.0190 |
| (reference sample) | | | | |

The compressive strength is comparable for all products.

Perforating the facing seems to improve the delamination strength slightly.

The thermal conductivity after accelerated ageing for the perforated product is comparable with the product with a gas permeable facing. The initial thermal conductivity of the product faced with a perforated aluminium-glass fibre tissue is slightly higher. This is due to the aluminium facing, which gives slightly higher readings in the thermal conductivity measuring instrument. [Fox Laser comp 314].

The product without perforations gave higher initial thermal conductivity and the increase in thermal conductivity following thermal ageing is higher compared to the perforated product.

### Example 3

Phenol foam was produced with a thickness of 40 mm. In the same way as in Example 2, the product was faced on both sides with a gas impermeable two layer aluminium-glass tissue facing. This insulation panel sample was then perforated on one side as described above. The pattern and depth of the perforations is shown in FIG. 2.

As with Example 2, these samples were placed in a drying oven and conditioned at 70° C. Alongside this sample was a reference sample which was non-perforated. Also present in this evaluation was a sample that was faced with plain glass tissue.

Table 4 gives the weight loss of these three samples as function of the drying time

TABLE 4
Weight loss as function of the drying time (product thickness 40 mm)

| Description | Data | | | |
|---|---|---|---|---|
| Product thickness [mm] | 40 | 40 | 40 | 40 |
| Drying time [hours] | 1 | 2 | 3 | 4 |
| Drying temperature [° C.] | 70 | 70 | 70 | 70 |
| Weight loss double sided aluminium foil - | 0.14 | 0.17 | 0.21 | 0.52 |
| glass fibre faced product no perforations | | | | |
| [w %] | | | | |
| Weight loss double sided aluminium foil - | 1.21 | 2.78 | 3.36 | 4.20 |
| glass fibre faced product single sided | | | | |
| perforated [w %] | | | | |
| Glass tissue (reference sample) [w %] | 3.04 | 4.45 | 4.94 | 5.93 |

Table 4 shows that the weight loss of the single sided perforated product is much higher compared to the weight loss of the product faced with an impermeable facing.

Table 5 shows the product properties of these 40 mm thick samples after 4 hours of drying at 70° C.

All measurements are performed according to EN13166 2001.

TABLE 5
Physical properties of perforated product (product thickness 40 mm).

| | | | | Thermal |
|---|---|---|---|---|
| | | | | Conductivity |
| | | | Thermal | after |
| | Compressive | Delamination | Conductivity | 25 weeks at |
| | Strength | Strength | Initial | 70° C. |
| Description | [kPa] | [kPa] | [W/m · K] | [W/m · K] |
| Weight loss double sided | 162 | 89 | 0.0197 | 0.0201 |
| aluminium foil - glass fibre faced | | | | |
| product (no perforations) | | | | |
| Weight loss double sided | | | | |
| aluminium foil - glass fibre faced | 152 | 84 | 0.0188 | 0.0196 |
| product (single side perforated) | | | | |
| Glass tissue (reference sample) | 169 | 87 | 0.0177 | 0.0188 |

The invention is not limited to the embodiments hereinbefore described which may be varied in detail.

1. A method of reducing drying times of a phenolic foam board in the manufacture of a phenolic foam board comprising the steps of:
leading a pre-perforated base facing of substantially gas impermeable material to a lay down area;
laying liquid phenolic foam reactants down on the base facing;
leading a pre-perforated upper facing of substantially gas impermeable material over the foam reactants;
forming a foam body by autohesively bonding the upper and lower facings to the foam reactants, without the liquid foam reactants bleeding through the facings, to form the foam body including the attached upper and lower facings;
leading the foam body including the attached upper and lower facings thus formed through an oven to form the foam board;
cutting the foam board thus formed to a desired length; and
oven-drying the foam board at the same temperature and for the same duration as is necessary to dry an equivalent foam board of the same thickness that had facings of gas permeable glass fibre material to produce the foam board having an aged thermal conductivity of less than 0.02 W/m.K.

2. The method as claimed in claim 1 wherein the facing comprises a metallic foil.

3. The method as claimed in claim 2 wherein the facing comprises an aluminium foil.

4. The method as claimed in claim 2 wherein the facing is a laminate.

5. The method as claimed in claim 4 wherein the laminate comprises a metallic foil laminated onto a glass tissue.

6. The method as claimed in claim 4 wherein the laminate comprises a metallic foil laminated onto a Kraft paper.

7. The method according to claim 1 wherein the perforations are from about 0.05 to about 2 mm in diameter.

8. The method according to claim 7 wherein the perforations are spaced from about 2 to about 50 mm apart.

9. The method according to claim 1 wherein the perforations are from about 0.1 to about 1.5 mm in diameter.

10. The method according to claim 9 wherein the perforations are spaced from about 3 to about 30 mm apart.
